(19) United States
(12) Patent Application Publication
(10) Pub. No.: US 2019/0308860 A1
(43) Pub. Date: Oct. 10, 2019

(54) VEHICLE HAVING A LATERAL LIFTING DEVICE

(71) Applicant: BULMOR Holding GmbH, Wien (AT)

(72) Inventor: Herbert SCHUETZENEDER, Windhaag bei Perg (AT)

(73) Assignee: BULMOR Holding GmbH, Wien (AT)

(21) Appl. No.: 16/315,285

(22) PCT Filed: Jul. 24, 2017
(86) PCT No.: PCT/AT2017/060187

§ 371 Date: Jan. 4, 2019

(30) Foreign Application Priority Data
Jul. 26, 2016 (AT) A50678/2016

(51) Int. Cl. B66F 9/10; B66F 9/075; B62D 3/14; B62D 5/18

(52) U.S. Cl. CPC B66F 9/10; B66F 9/07586; B66F 9/07568; B62D 3/14; B62D 5/18; B66F 9/07572

(57) ABSTRACT

A vehicle has a lateral lifting device, in particular a side loader, including at least a first cross member and a second cross member, wherein the two cross members are coupled with one another by a connection construction that is disposed laterally outside the center, and wherein the lifting device is disposed in a free space between the two cross members. The first cross member has a first wheel pair, and the second cross member has a second wheel pair, wherein each of the individual wheels of the wheel pairs is mounted so as to rotate about an axis of rotation that is oriented vertically. The vehicle can be moved in a first travel direction parallel to a longitudinal axis of the vehicle, and in a second travel direction transverse to the longitudinal axis of the vehicle.

The invention relates to a vehicle having a lateral lifting device, in particular a side loader.

Forklifts that can be moved in multiple directions are known from WO 01/12493 A1 and WO 03/059799 A1.

The forklifts known from WO 01/12493 A1 and WO 03/059799 A1 have the disadvantage that they cannot be used off-road, or can be used only with restrictions, and therefore can be used only in restricted manner other than on level and paved surfaces, such as in industrial buildings.

It was the task of the present invention to create a forklift that can also be used on unpaved surfaces.

This task is accomplished by means of a vehicle in accordance with the claims.

According to the invention, a vehicle having a lateral lifting device, in particular a side loader, is configured. The vehicle comprises at least a first cross member and a second cross member, wherein the two cross members are coupled with one another by means of a connection construction that is disposed laterally outside the center, and wherein the lifting device is disposed in a free space between the two cross members, wherein the connection construction is disposed at the lateral edge of the cross members, so that the vehicle is configured in U shape in a top view, and wherein the two shanks of the vehicle configured in U shape, which shanks lie parallel to one another, are formed by the cross members, and the free space for accommodating the lifting device is configured on the open side of the U-shaped arrangement, wherein the first cross member has a first wheel pair, and the second cross member has a second wheel pair. Each of the individual wheels of the wheel pairs is mounted so as to rotate about an axis of rotation that is oriented vertically. The vehicle can be moved in a first travel direction parallel to a longitudinal axis of the vehicle, and in a second travel direction transverse to the longitudinal axis of the vehicle.

It is an advantage of the configuration of the vehicle according to the invention that the tilting stability of the vehicle is increased by means of the configuration of wheel pairs on the individual cross members. At the same time, the greatest possible maneuverability and flexibility of the vehicle is achieved by means of the rotating mounting of the individual wheels of the wheel pairs about a vertically oriented axis of rotation.

Furthermore, it can be practical if a first axle is configured on the first cross member, which serves to hold the first wheel pair, and that a second axle is configured on the second cross member, which serves to hold the second wheel pair. It is advantageous, in this regard, that increased stability or strength of the wheel holder can be achieved by forming an axle on which the individual wheels of the wheel pairs are configured. Furthermore, an axle can be easily built into the cross member and can also be easily taken out and replaced for maintenance purposes.

Furthermore, it can be provided that each of the individual wheels is held on a wheel holder, which wheel holder has a radial mounting having a horizontally oriented axis of rotation, for holding a wheel in rotatable manner, and an axial mounting having a vertically oriented axis of rotation, by means of which the wheel holder are mounted on the cross members so as to rotate freely about the vertically oriented axis of rotation. It is advantageous, in this regard, that such a wheel holder can be configured the same for each of the individual wheels, and therefore the complexity in the production of the vehicle can be reduced, and thereby the quality of the vehicle can be improved.

Furthermore, it can be provided that the axles are held, in each instance, approximately in the center of the cross members with reference to a horizontal point of rotation, mounted on pendulum bearings. It is advantageous, in this regard, that uneven areas in the substratum can be balanced out by means of the pendulum-mounted axles. Furthermore, an angle of inclination of the cross members relative to the substratum can be actively adjusted by means of the pendulum-mounted axles.

Alternatively to this, it can be provided that the axles are held, in each instance, outside of the center of the cross members with reference to a horizontal point of rotation, mounted on pendulum bearings. It is advantageous, in this regard, that by means of this measure, the result can be achieved, in spite of a change in the angle of inclination, that the distance of the holding fork from the floor, for example, is not unintentionally changed when the angle of inclination is changed. This can be achieved in that the point of rotation is disposed as close as possible in the region of the forklift fork.

According to a further development, it is possible that the axles are coupled with the respective cross member by means of at least one setting means disposed at a distance from the horizontal point of rotation. It is advantageous, in this regard, that the inclination of the cross members relative to the axle can be actively adjusted by the setting means. The farther the setting means are spaced apart from the point of rotation, the lower the force acting on the setting means, wherein the required setting path is also increased with an increasing distance of the setting means from the point of rotation. The setting means can be configured in the form of a hydraulic cylinder, for example. Furthermore, it is also conceivable that the setting means is configured in the form of an electric motor having a setting spindle, for example.

Furthermore, it can be practical if the individual wheels are held on the axles of the cross members by means of the axial mounting having a vertically oriented axis of rotation, configured on the wheel holder so as to rotate freely. It is advantageous, in this regard, that the result can be achieved, by means of the wheel holder held on the axles, that the vertically oriented axis of rotation of the wheel holder is oriented at a right angle to the substratum in as many cases of use as possible.

Furthermore, it can be provided that the axles, in each instance, are coupled with the respective cross member by means of two setting means that are spaced apart from one another, and that the axle can be pivoted with reference to the cross member, about a virtual horizontal point of rotation, by means of adjustment of the setting means. It is advantageous, in this regard, that the axles are not mounted at a fixed point of rotation relative to the cross members, but rather the point of rotation can be freely displaced both in terms of height and in terms of width by means of the two setting means, and thereby the flexibility of the vehicle can be increased.

Furthermore, it can be provided that a rotary motor is configured, on which a pinion is disposed, and is coupled with a gear wheel configured on the wheel holder, by means of a mechanical coupling, preferably a circulating traction means. It is advantageous, in this regard, that the result can be achieved, by means of such a configuration of a rotary motor for changing the angle of the wheel holder, that the wheel holder is theoretically held so as to freely rotate by 360° on the cross member or on the axle. Alternatively to a circulating traction means, the mechanical coupling can be implemented by means of a gear wheel, for example.

According to a special version, it is possible that the traction means is configured in the form of a drive chain. It is advantageous, in this regard, that such a drive chain is robust and not sensitive to dirt. Furthermore, that it can absorb relatively high forces. In an alternative variant, it can also be provided that the traction means is formed by a toothed belt, for example.

In accordance with an advantageous further development, it can be provided that the rotary motor is configured as a hydraulic motor. Such a hydraulic motor can apply the greatest possible force on the traction means with the smallest possible construction.

In an alternative embodiment variant, it can be provided that a hydraulic cylinder is configured, by means of which the wheel holder can be rotated about the vertically oriented axis of rotation. A hydraulic cylinder can be built into the vehicle in space-saving manner, and furthermore can be easily controlled.

In particular, it can be advantageous if each of the individual wheels of the vehicle is coupled, in each instance, with a drive motor for drive of the wheels. It is advantageous, in this regard, that by means of this measure, the off-road capacity of the vehicle can be improved. Furthermore, the individual drive motors can have a different drive speed, in accordance with the currently present turning angle, and thereby tensions within the vehicle can be prevented. The drive motors can furthermore be held on the wheel holder, and thereby be rotated relative to the individual cross members, together with the wheel holder.

Furthermore, it can be provided that the drive motor for driving the wheels is configured as a hydraulic motor. It is advantageous, in this regard, that a hydraulic motor can apply the greatest possible torque at the lowest possible construction height and weight. Furthermore, a hydraulic motor has the least possible susceptibility to breakdown.

In accordance with an advantageous further development, it can be provided that the wheel holder can be rotated in the vertically oriented axis of rotation by a maximal angle between 180° and 400°, in particular between 210° and 360°, preferably between 250° and 290°. It is advantageous, in this regard, that during rotation of the wheel holder in such a maximal rotation angle range, the result can be achieved that the vehicle remains maneuverable in all directions, and nevertheless, the feed line for the energy supply of the drive motor of the individual wheels can be configured in the simplest possible manner, since no multiple rotations of the wheel holder take place.

Furthermore, it can be provided that at least two of the wheels or even all of the wheels have a diameter between 10 inches and 50 inches, in particular between 12 inches and 50 inches, preferably between 14 inches and 50 inches. Wheels having a diameter in the indicated range can still be rotated surprisingly well at great off-road capability, so as to achieve good maneuverability of the vehicle.

Furthermore, it can be provided that a contact plane is configured, in which elongated objects picked up by the lifting device can be laid down, wherein the contact plane is disposed above the wheels. It is advantageous, in this regard, that such a contact plane facilitates transport of long rod material, wherein the freedom of movement of the wheels is as great as possible.

It is clear to a person skilled in the art that analogous to an axial mounting with a vertically oriented axis of rotation, which is configured in the wheel holder, it can also be provided that the corresponding axial mounting, by means of which the wheel holder are mounted on the cross members so as to rotate about the vertically oriented axis of rotation, can be configured directly on the cross members or the axles, and thereby fulfill the same function.

The radial mounting for holding a wheel on the wheel holder in rotatable manner can also be configured directly in one of the wheels.

For a better understanding of the invention, it will be explained in greater detail using the following figures.

These show, each in a greatly simplified, schematic representation:

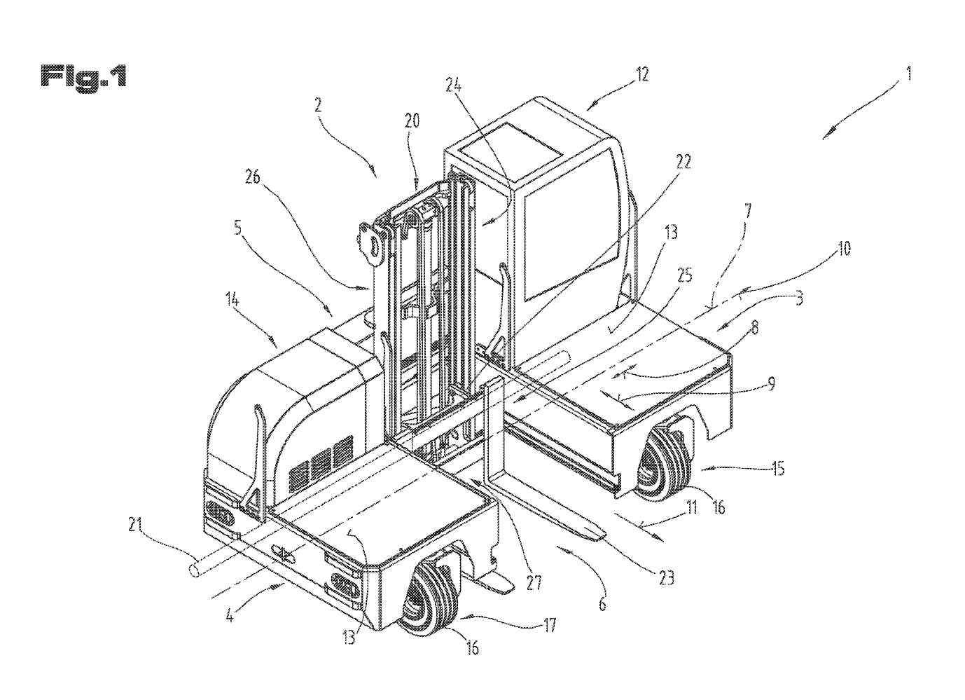

FIG. 1 a perspective view of a vehicle having a lateral lifting device, at a slant from above;

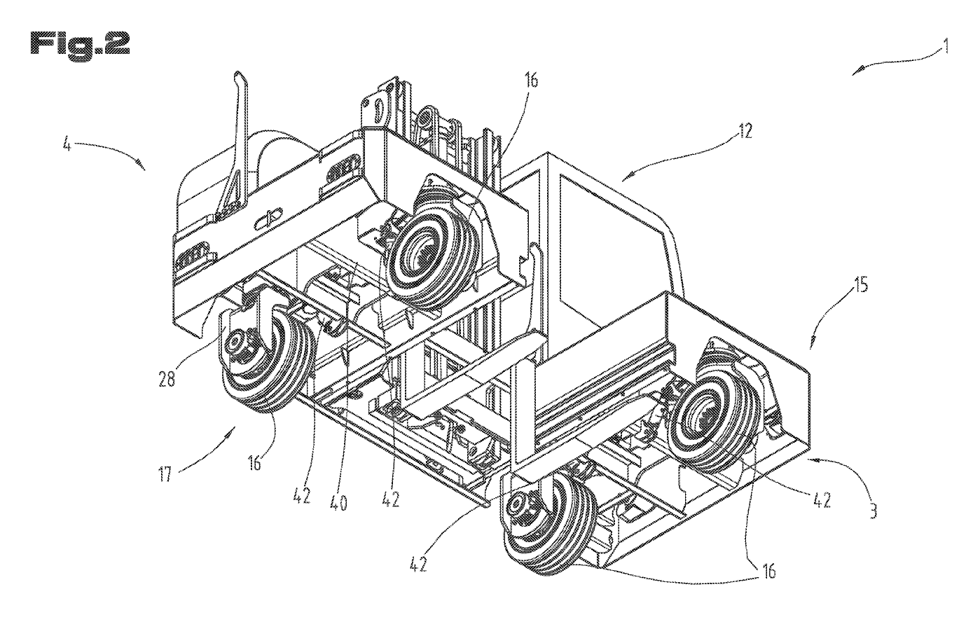

FIG. 2 a perspective view of a vehicle having a lateral lifting device, at a slant from below, with the position of the wheels in a first position;

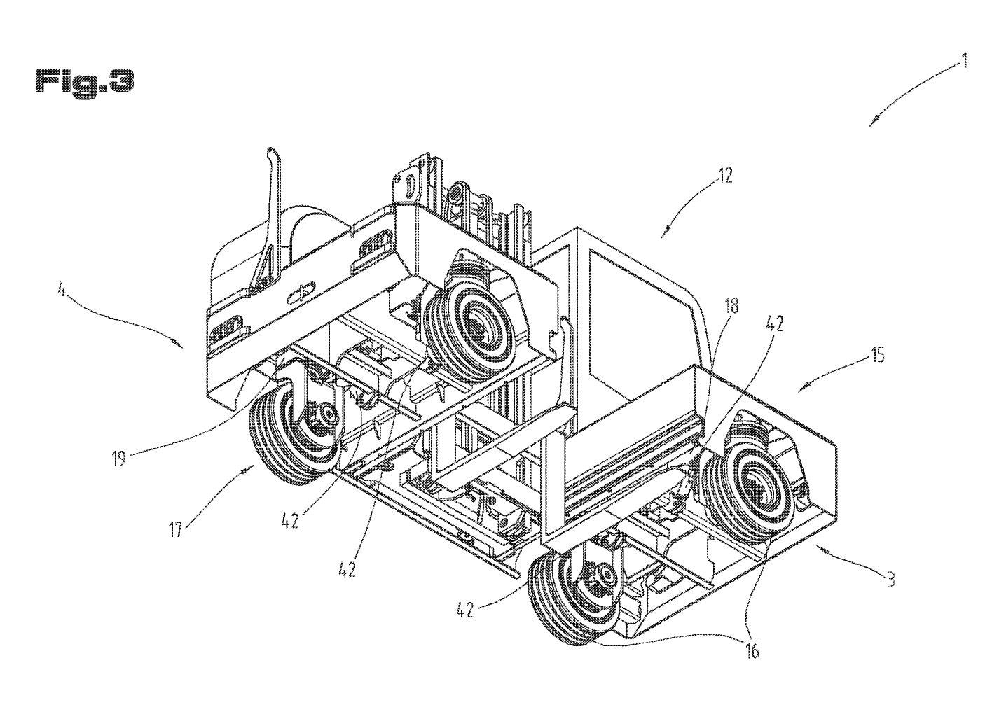

FIG. 3 a perspective view of a vehicle having a lateral lifting device, at a slant from below, with the position of the wheels in a second position;

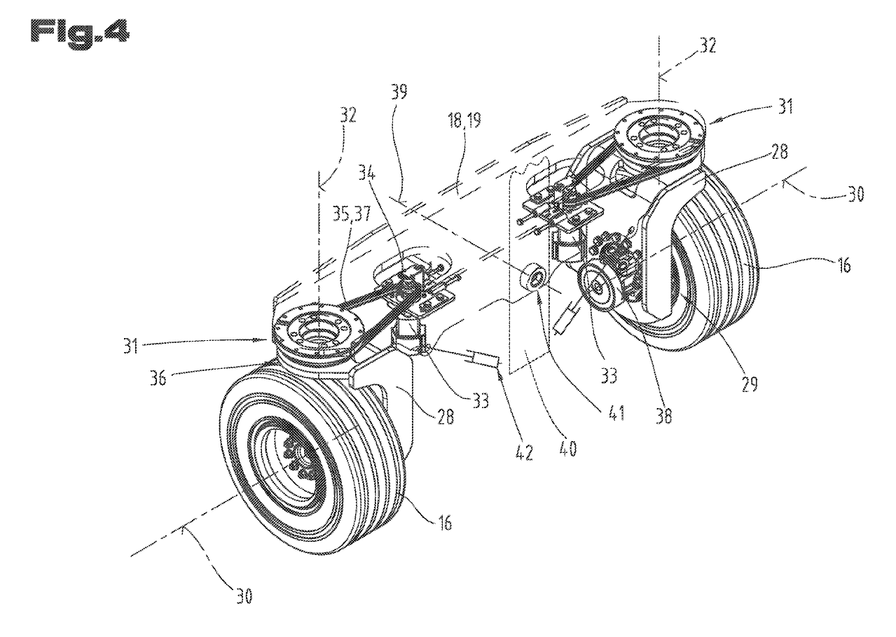

FIG. 4 a perspective view of an axle having wheel holders mounted on it so as to rotate;

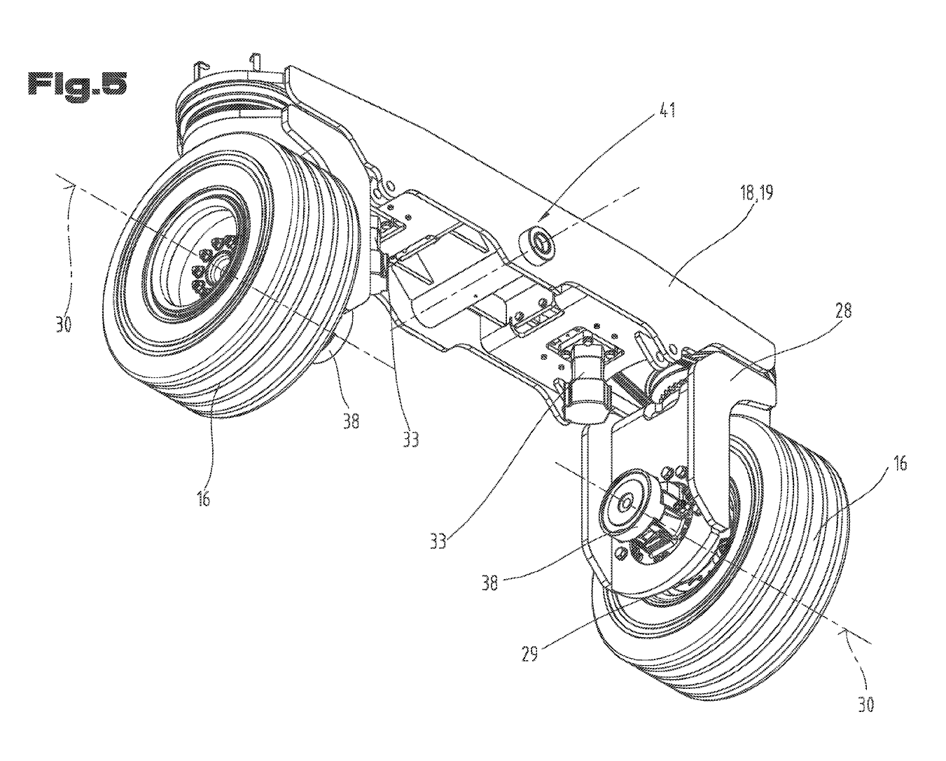

FIG. 5 a further perspective view of an axle having wheel holders mounted on it so as to rotate;

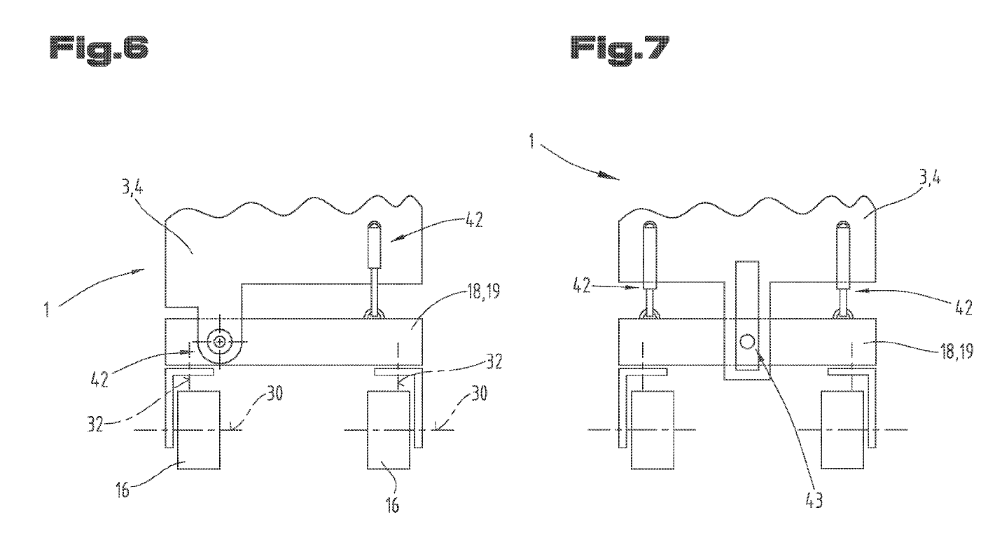

FIG. 6 a schematic representation of a further exemplary embodiment of the vehicle having a point of rotation of the axle suspension outside of the center;

FIG. 7 a schematic representation of a further exemplary embodiment of the vehicle having two setting means and a slide mounting;

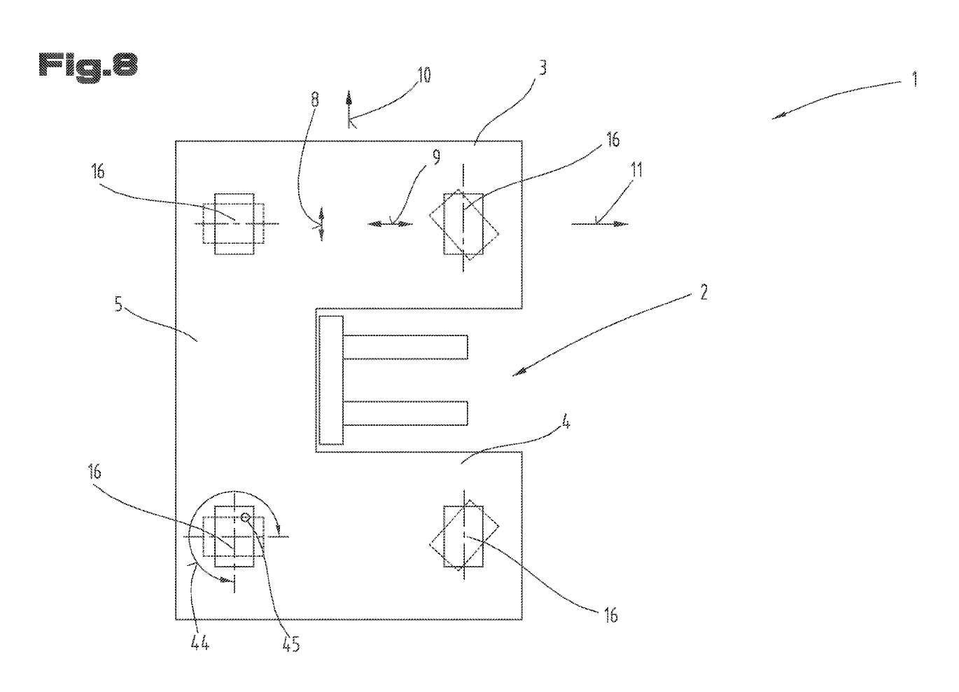

FIG. 8 a schematic top view of a further exemplary embodiment of the vehicle.

As an introduction, it should be stated that in the different embodiments described, the same parts are provided with the same reference symbols or the same component designations, wherein the disclosures contained in the description as a whole can be transferred analogously to the same parts having the same reference symbols or the same component designations. Also, the position information chosen in the description, such as top, bottom, lateral, etc., for example, refers to the figure being directly described and shown, and this position information must be transferred analogously to the new position in the event of a change in position.

FIG. 1 shows a perspective view from above of a vehicle 1 having a lateral lifting device 2. Such a vehicle 1 is also referred to as a side loader in technical terminology.

In FIGS. 2 and 3, the vehicle 1 is shown in further perspective representations from below, wherein once again, the same reference symbols or component designations as in the preceding figures, in each instance, are used for the same parts. In order to avoid unnecessary repetition, reference is made to the detailed description in the preceding figures, in each instance, or this is pointed out.

The following description is based on looking at the different representations of the first exemplary embodiment of the vehicle 1 in FIGS. 1 to 3 together, wherein not all the component numbering is entered in each individual one of the figures, but rather, for the sake of clarity, the components are only numbered in those figures in which they can be seen particularly well. It is assumed that it is clear to a person skilled in the art how different views from different viewing angles can be combined with one another.

The vehicle 1 has a first cross member 3 and a second cross member 4, which are coupled with one another by means of a connection construction 5. In particular, the two cross members 3, 4 and the connection construction 5 are coupled with one another in such a manner that a free space 6 occurs on one side of the vehicle 1. Seen in a top view, the vehicle 1 has a U-shaped shaping, wherein the two parallel shanks of the U are formed by the first cross member 3 and the second cross member 4.

In order to make the free space 6 as large as possible, the connection construction 5, viewed in a top view of the vehicle 1, is disposed laterally off-center. In a preferred embodiment variant, the connection construction 5 is disposed as far as possible from the edge 14 of the cross members 3, 4, so that the free space 6 is as great as possible. Stated in different words, viewed in a top view, the connection construction 5 is at as great a distance as possible from the longitudinal axis 7 of the vehicle 1 which axis lies at the center.

A further factor for the size of the free space 6 is the width of the connection construction 5. The narrower the connection construction 5 is structured, the wider the free space 6 can be. For this reason, the connection construction 5 should demonstrate the greatest possible shape rigidity and torsion rigidity, at the smallest possible dimensions. This can be achieved, for example, in that the connection construction 5 is structured in the form of a framework. For this purpose, individual metal sheets can be welded to one another, so as to form the connection construction 5.

In an alternative variant, it can also be provided that the connection construction 5 is welded together from different individual metal sheets in a profile construction, or that a metal sheet is bent to form a frame profile.

The cross members 3, 4 can also be structured as a sheet-metal construction, wherein individual metal sheets can be welded together to form the respective cross member 3, 4. In particular, it can be provided that the cross members 3, 4 and the connection construction 5 are each pre-fabricated as a separate, independent welded construction, and joined together in a further assembly step.

Alternatively, it can be provided that the cross members 3, 4 and the connection construction 5 are formed from continuous metal sheets.

The direction that lies parallel to the longitudinal axis 7 of the vehicle 1 is defined as the longitudinal direction 8 of the vehicle 1. Seen in a top view, the transverse direction 9 of the vehicle 1 is configured at an angle of 90° to the longitudinal direction 8 of the vehicle 1.

Preferably, it can be provided that the vehicle 1 can be moved in a first travel direction 10 that is oriented in the longitudinal direction 8 of the vehicle 1. Furthermore, it can be provided that the vehicle 1 can be moved in a second travel direction 11, which is oriented in the transverse direction 9 of the vehicle 1. Of course, it can be provided that the vehicle 1 can be steered, both when moving in the first travel direction 10 and when moving in the second travel direction 11, and therefore make a transition from straight-ahead travel to curved travel, in one of these travel directions 10, 11.

Of course, it can be provided that the vehicle 1 is moved both in forward travel and reverse travel with regard to the travel directions 10, 11.

Furthermore, it can be provided that the vehicle 1 is moved in any desired travel direction that lies at any desired angle between the first travel direction 10 and the second travel direction 11.

In a predominant travel position, also referred to as the first travel direction 10, it can be provided that the first cross member 3 is at the front during forward travel, so that the first cross member 3 can also be referred to as the front cross member. The second cross member 4, analogous to this, can be referred to as the rear cross member.

Furthermore, it can be provided that a driver's cab 12 is disposed on the vehicle 1, wherein the driver's cab 12 is preferably disposed on the first cross member 3. In the embodiment variant of the vehicle 1 according to FIGS. 1 to 3, the driver's cab 12 is disposed on the left side of the vehicle 1, seen in the first travel direction 10. Stated in different words, it can be provided that the driver's cab 12 is disposed on the same side of the vehicle 1 as the connection construction 5. Within the driver's cab 12, a driving position is disposed, on which all the operating elements are disposed, and where a vehicle driver who controls the vehicle 1 can take his/her place. In a further development, it can be provided that the driver's cab 12 and/or the driving position is/are configured so as to rotate about a vertical axis relative to the cross members 3, 4, so that the main viewing direction of the vehicle driver can be adapted to the respective set travel direction.

Furthermore, it can be provided that a contact plane 13 is configured on the first cross member 3 and/or on the second cross member 4, on which elongated objects picked up by the lifting device 2 can be set down. The contact plane 13 can be formed by the arrangement of the driver's cab 12 and the connection construction 5 as described.

The first cross member 3 preferably comprises a first wheel pair 15 having a least two individual wheels 16, and the second cross member 4 preferably comprises a second wheel pair 17, also having at least two individual wheels 16.

The first wheel pair 15 is preferably disposed on a first axle 18, and the second wheel pair 17 is preferably disposed on a second axle 19.

Alternatively to this, it can also be provided, in an exemplary embodiment that is not shown, that the wheel pairs 15, 17 each have an individual wheel suspension. In the case of such an individual wheel suspension, an angle inclination of the cross members 3, 4 and thereby of the lifting device 2 can be adjustable by means of adjusting the distance of the welded construction of the cross members 3, 4 relative to the individual wheels 16 of the wheel pairs 15, 17.

In particular, it can be provided that to steer the vehicle 1 during travel in one of the travel directions, only the first wheel pair 15 or the second wheel pair 17 is steered so as to be able to steer the vehicle 1. For this purpose, it can be provided that the respective other wheel pair 15, 17 remains in the pre-set position.

Furthermore, it is also conceivable that both the first wheel pair 15 and the second wheel pair 17 can be steered. In this way, the possible curve radius of the vehicle 1 can be reduced in size.

The cross members 3, 4, seen in a top view, can have an approximately rectangular cross-section. In particular, it can be provided that the first cross member 3 serves to hold the driver's cab 12, and the second cross member 4 serves to hold a drive motor. The vehicle 1 can be powered by means of an internal combustion engine, such as a diesel engine or a gasoline engine, which are preferably disposed in the second cross member 4. This internal combustion engine can be coupled with a generator, for example, wherein all the setting and travel drives of the vehicle 1 can be configured in the form of an electric motor.

Alternatively to this, it can be provided that the internal combustion engine is coupled with a hydraulic assembly, and that the setting drives and travel drives are configured in the form of a hydraulic motor.

In yet another embodiment variant, it can be provided that the setting drives and travel drives are configured in the form of an electric motor, wherein the drive energy is provided not by a generator, but rather by a battery.

As is further evident from FIGS. 1 to 3, it can be provided that the lifting device 2 comprises a lift mast 20. The lift mast 20 serves to lift the components 21 to be transported. A carriage 22 is held on the lift mast 20, which carriage can be displaced in the vertical direction relative to the cross members 3, 4. Forklift forks 23 are disposed on the carriage 22, which forks serve to hold the component 21 to be transported. Alternatively to forklift forks 23, other holding elements can also be disposed on the carriage 22 to hold a load.

As can be seen particularly well when looking at FIGS. 1 to 3 together, the lifting device 2, which comprises the lift mast 20, is accommodated in the free space 6 of the vehicle 1. In particular, it can be provided, in this regard, that a first guide unit 25 is disposed on a first side 24 of the lift mast 20, and a second guide unit 27 is disposed on a second side 26 of the lift mast 20. The guide units 25, 27 serve to be able to hold the lift mast 20 so as to be displaceable in the free space 6, in the transverse direction 9 of the vehicle 1. As a result, the forklift forks 23 and thereby the component 21 to be transported can be pushed laterally out of the vehicle 1 in the transverse direction 9.

FIG. 4 shows a perspective view of the axle 18, 19, on which a wheel pair 15, 17 is disposed, at a slant from above, wherein once again, the same reference symbols or component designations are used for the same parts as in the preceding FIGS. 1 to 3. In order to avoid unnecessary repetition, reference is made to the detailed description of the preceding FIGS. 1 to 3, i.e. this is pointed out.

FIG. 5 shows a perspective view of the axle 18, 19 at a slant from below, wherein once again, the same reference symbols or component designations are used for the same parts as in the preceding FIGS. 1 to 4. In order to avoid unnecessary repetition, reference is made to the detailed description of the preceding FIGS. 1 to 4, i.e. this is pointed out.

The following description relates to a combination of FIGS. 4 and 5.

The representation in FIGS. 4 and 5 can involve both the first axle 18 and the second axle 19. The two axles 18, 19 of the vehicle 1 can be configured to be the same. Alternatively to this, it is also conceivable that the first axle 18 and the second axle 19 of the vehicle 1 are configured differently.

As is evident from FIG. 4, it can be provided that a wheel holder 28 is held on the axle 18, 19, in the lateral edge region, in each instance, which holder serves to hold the wheels 16. The wheel holder 28 has a radial mounting 29, on which the wheel 16 is held so as to rotate on the wheel holder 28, about a horizontally oriented axis of rotation 30.

In this regard, it can be provided that the radial mounting 29 is disposed in the wheel 16, and that a journal is disposed on the wheel holder 28, which journal interacts with the radial mounting 29.

Alternatively to this, it can be provided that the radial mounting 29 is directly configured in the wheel holder 28, and that the wheel 16 is firmly connected with the journal that interacts with the radial mounting 29.

The wheel holder 28 can be configured in L shape, wherein one side of the wheel holder 28 faces the axle 18, 19, and a second side of the wheel holder 28 faces the wheel 16.

In the exemplary embodiment shown, the wheel holder 28 is configured as a bent part, wherein lateral struts are provided on the wheel holder 28 to increase its stability.

In a further exemplary embodiment, it can be provided that the wheel holder 28 is configured as a cast part.

As can furthermore be seen in FIG. 4, it can be provided that an axial mounting 31 is configured on the wheel holder 28, by means of which mounting the wheel holder 28 is held on the axle 18, 19 so as to rotate about a vertically oriented axis of rotation 32. The axial mounting 31 can be configured in the form of a roller bearing ring, for example. Alternatively to this, it is also conceivable that the axial mounting 31 is formed by a slide mounting.

By means of the axial mounting 31, the result can be achieved that each of the individual wheel holders 28 can be rotated individually and independent of one another, relative to the cross member 3, 4 or, respectively, to the axle 18, 19.

In particular, it is provided that the vertically oriented axis of rotation 32 of the axial mounting 31 and the horizontally oriented axis of rotation 30 of the radial mounting 29 are oriented at an angle of 90° relative to one another.

The axle 18, 19 or the wheel holder 28 are preferably configured in such a manner that the wheel holder 28 is held on the axle 18, 19 so as to rotate freely about the vertically oriented axis of rotation 32, at an angle of 360°.

Furthermore, a rotary motor 33 can be provided, which is configured to drive the rotational movement of the wheel holder 28 about the vertically oriented axis of rotation 32.

As can be seen in FIG. 4, the rotary motor 33 can be coupled with a pinion 34, which is movement-coupled with a gear wheel 36 by way of a traction means 35. In this regard, the gear wheel 36 is directly coupled with the wheel holder 28, and serves to introduce a rotational movement of the wheel holder 28 about the vertically oriented axis of rotation 32. In this regard, the traction means 35 is circumferentially tensed between the pinion 34 and the gear wheel 36.

In a preferred embodiment variant, it is provided that the traction means 35 is configured as a drive chain 37.

In a further embodiment variant, it can also be provided that the traction means 35 is configured in the form of a toothed belt.

In yet another initial variant, it can also be provided that the pinion 34 of the rotary motor 33 and the gear wheel 36 on the wheel holder 28 are movement-coupled by means of a further gear wheel that lies between them.

In yet another embodiment variant, it can be provided that the rotary motor 33 is placed on the vertically oriented axis of rotation 32, and that an output shaft of the rotary motor 33 is directly movement-coupled with the wheel holder 28.

The rotary motor 33 can be configured, for example, in the form of a hydraulic motor or perhaps in the form of an electric motor.

In yet another embodiment variant, not shown, it can be provided that a different setting means, such as a hydraulic cylinder, for example, is configured for rotating the wheel holder 28 with reference to the vertically oriented axis of rotation 32.

Furthermore, it can be provided that a drive motor 38 for driving the wheels 16 is configured on the wheel holder 28. The drive motor 38 for driving the wheels 16 can also be configured in the form of a hydraulic motor or an electric motor. In particular, it can be provided that at least two of the wheels 16 of the vehicle 1 are driven by means of a separate drive motor 38.

In a further embodiment variant it can be provided that three of the wheels 16 are driven by a separate drive motor 38.

In yet another embodiment variant, it can be provided that all of the wheels 16 are driven by a separate drive motor 38.

Furthermore, it can be provided that the axle 18, 19 is held on an axle holder 40 of the cross member 3, 4, so as to rotate about a horizontal axis of rotation 39. In this way, the result can be achieved that the axle 18, 19 is held on the cross member 3, 4 in pendulum manner. In order to achieve this, it can be provided that a rotary mounting 41 is configured, which acts between the axle 18, 19 and the axle holder 40.

As shown in FIG. 4, the rotary mounting 41 can be disposed centered on the axle 18, 19. Thereby the vertically oriented axes of rotation 32 can both have the same normal line distance from the horizontal axis of rotation 39 of the axle 18, 19. Thereby, in the event of tilting of the axle 18, 19 relative to the cross member 3, 4, the two wheels 16 disposed on an axle 18, 19 are moved by the same amount, in opposite directions, in each instance, in the direction toward the cross member 3, 4 or away from it.

As can be seen in FIG. 4, it can be provided that a setting means 42 is disposed at a distance from the horizontal axis of rotation 39, which means serves to set the inclination between the axle 18, 19 and the cross member 3, 4. In this regard, the setting means 42 can be coupled with the axle 18, 19 at a first point of attack, and coupled with the cross member 3, 4 at a second point of attack, and thereby extend between these points.

The setting means 42 can be configured in the form of a hydraulic cylinder, for example.

In an alternative embodiment variant, it can also be provided that the setting means 42 is configured in the form of a spindle drive.

In particular, the angle between the axle 18, 19 and the cross member 3, 4 can be adjusted by changing the length of the setting means 42. As can be seen in the embodiment variant according to FIG. 4, it can be provided that a setting means 42 is disposed on both sides of the axle 18, 19. In this way, the result can be achieved that the force acting on the setting means 42 is cut in half. In this regard, however, attention must be paid to ensure that the two setting means 42 are moved synchronously relative to one another, since the mechanical system composed of rotary mounting 41 and two setting means 42 is mechanically over-determined. In order to achieve sufficiently precise positioning of the setting means, corresponding sensors for length determination can be provided on the setting means 42.

In a further embodiment variant, it can also be provided that the setting means 42 is configured in the form of a rotary motor, which motor is disposed, for example, on the cross member 3, 4, and the power take-off shaft of which motor is coupled with the axle 18, 19. This coupling of the power take-off shaft of the rotary motor with the axle 18, 19 can also be implemented, for example, with the interposition of a step-up gear unit.

In a further development, it can also be provided that a sensor is disposed in the region of the connection construction 5 or at another location, which sensor measures twisting of the connection construction 5 or the torque that occurs at the connection construction 5. Using the sensor data, excessive twisting of the connection construction 5 can be balanced out using the individual setting means 42, by setting a different inclination of the first axle 18 and the second axle 19.

This can be necessary, in particular, if the distance between the first axle 18 and the second axle 19 has a great length, and if, at the same time, the substratum on which the vehicle 1 is to be operated is very uneven.

FIG. 6 shows a schematic representation of a further exemplary embodiment of the vehicle 1, wherein once again, the same reference symbols or component designations are used for the same parts as in the preceding FIGS. 1 to 5. In order to avoid unnecessary repetition, reference is made to the detailed description of the preceding FIGS. 1 to 5, i.e. this is pointed out.

As shown in the alternative embodiment variant according to FIG. 6, it is also conceivable that the rotary mounting 41 is disposed not centered on the axle 18, 19, but rather the rotary mounting 41 is disposed close to one of the wheels 16. In this way, the result can be achieved that in the event of tilting of the axle 18, 19 relative to the cross member 3, 4, the distance of at least one of the wheels from the cross member 3, 4 remains unchanged or at least almost unchanged, and only the distance of the second wheel 16 from the cross member 3, 4 is changed.

In the exemplary embodiment according to FIG. 6, only one setting means 42 is present, wherein the setting means 42 is disposed on a side of the axle 18, 19 that lies opposite the rotary mounting 41.

FIG. 7 shows a schematic representation of a further embodiment variant of the connection between the cross member 3, 4 and the axle 18, 19, wherein once again, the same reference symbols or component designations are used for the same parts as in the preceding FIGS. 1 to 6. In order to avoid unnecessary repetition, reference is made to the detailed description of the preceding FIGS. 1 to 6, i.e. this is pointed out.

As can be seen in FIG. 7, it can be provided that a first setting means 42 is disposed on the first side of the axle 18, 19, and a second setting means 42 is disposed on the second side of the axle 18, 19, wherein the axle 18, 19 is not connected with the cross member 3, 4 by way of a fixed point of rotation, but rather is secured to prevent horizontal displacement between axle 18, 19 and cross member 3, 4 by way of a linear guide 43. By means of the linear guide 43, vertical displacement between axle 18, 19 and cross member 3, 4 is possible.

The linear guide 43 can be configured in the form of a sliding block guide, for example.

Alternatively to this, it can also be provided that the linear guide 43 is configured in the form of some other shape-fit slide bearing guide, such as a swallowtail guide, for example.

In yet another alternative variant, it can also be provided that the linear guide 43 is configured in the form of a circulating ball bearing guide.

By means of the use of a linear guide 43 together with two setting means 42 that act independently of one another, the result can be achieved that for tilting of the axle 18, 19 relative to the cross member 3, 4 by a specific angle, the horizontal axis of rotation 39 can be configured as a virtual axis, and can assume any position between the two setting means 42.

For example, it is conceivable that one of the two setting means 42 is lengthened by an amount x, and the second of the two setting means 42 is shortened by the same amount x, and therefore the virtual horizontal axis of rotation 39 lies precisely between the two setting means 42. In a further application case, it is conceivable that in order to set a tilt angle of the axis, one of the two setting means 42 is left unchanged in its position, and the second of the two setting means 42 is lengthened or shortened by a certain amount. As a result, an axis of rotation 39 is obtained that lies precisely at the point of attack of the setting means 42 that was left unchanged in its position. Of course, it is also conceivable to set any desired position of the horizontal axis of rotation 39 by means of a correspondingly great adjustment of the setting means 42.

In yet another use variant, it is conceivable that the two setting means 42 are simultaneously lengthened or shortened, and thereby the distance of the cross member 3, 4 relative to the axle 18, 19 is changed without changing the tilt of the cross member 3, 4 relative to the axle 18, 19.

FIG. 8 shows a further exemplary embodiment of the vehicle 1 in a schematic view from below, wherein once again, the same reference symbols or component designations are used for the same parts as in the preceding FIGS. 1 to 7. In order to avoid unnecessary repetition, reference is made to the detailed description of the preceding FIGS. 1 to 7, i.e. this is pointed out.

As can be seen in FIG. 8, it can be provided that each of the wheels 16 can be rotated individually and independent of one another with reference to its travel direction relative to the vehicle 1. It appears optimal, in this regard, if each of the wheels 16 can be rotated by an angle of rotation 44 of about 270° relative to the vehicle 1. This appears practical for several reasons. For one thing, the result can be achieved, by means of limited ability of the wheel 16 to rotate relative to the cross member 3, 4, that various power supply lines, such as electric lines or hydraulic lines, can be passed from the cross member 3, 4 to the respective wheel holder 28, so as to be able to supply the drive motor 38 for the wheels 16 with energy, for example.

On the other hand, the result can thereby be achieved that not only in the main orientation of the wheels 16 in the first travel direction 10, the wheels 16 of the second cross member 4, for example, can be pivoted either 90° to the left or 90° to the right, so as to be able to achieve maximal steering lock or a maximal steering movement of the vehicle 1. In the case of a main orientation of all the wheels 16 in the second travel direction 11, for example, those wheels 16 that are disposed in the region of the connection construction 5 can also be pivoted by an angle of 90° to the left or to the right, away from the second travel direction 11, so as to allow maximal turn-in of the vehicle 1.

Since it is not always absolutely necessary for the maximal steering lock to amount to +/−90°, it can also be practical if the maximal angle of rotation 44 is less than 270°.

Furthermore, an angle of rotation sensor 45 can be provided, which is configured for detection of the angle of rotation 44 and indicates the current position of all the wheels 16.

Different possibilities as to how the individual wheels 16 can be oriented exist for moving the vehicle 1. For example, it is conceivable that all the wheels 16 are oriented in the first travel direction 10. In this regard, either the wheels 16 of the first cross member 3 or the wheels 16 of the second cross member 4 can be steered in the same way, for example, wherein the wheels 16 of the respective other cross member 3, 4 remain unchanged, oriented in the first travel direction 10. This corresponds to conventional steering of a side loader.

Furthermore, it is also conceivable that to drive along a curve, both the wheels 16 of the first cross member 3 and the wheels 16 of the second cross member 4 are steered.

Analogous to the travel direction 10 as described, it can also be provided that all the wheels 16 are oriented in the second travel direction 11, and that either the wheels 16 disposed in the region of the connection construction 5 or those disposed in the region of the free space 6 are steered jointly.

In yet another operation variant, it is conceivable that all the wheels 16 are oriented at an angle of 45° between the first travel direction 10 and the second travel direction 11, and thereby the vehicle 1 can be displaced parallel at an angle of 45°. This possibility of parallel displacement is, of course, possible in step-free manner between the first travel direction 10 and the second travel direction 11.

In another operation variant of the vehicle 1, it can be provided that all the wheels 16 are oriented tangential to a vehicle center point, and thereby the vehicle 1 can be rotated about the vehicle center point.

The exemplary embodiments show possible embodiment variants, wherein at this point, it should be noted that the invention is not restricted to the embodiment variants of the invention that are specifically shown, but rather, instead, various combinations of the individual embodiment variants with one another are possible, and this variation possibility lies within the ability of a person skilled in the art of this technical field, on the basis of the teaching for technical action provided by the present invention.

The scope of protection is determined by the claims. However, the description and the drawing must be referred to for an interpretation of the claims. Individual characteristics or combinations of characteristics of the different exemplary embodiments that are shown and described can represent independent inventive solutions on their own. The task on which the independent inventive solutions are based can be derived from the description.

All the information regarding value ranges in the present description should be understood to mean that any and all partial ranges of them are included; for example, the statement 1 to 10 should be understood to mean that all partial ranges, starting from the lower limit 1 and including the upper limit 10, are included, in other words all the partial ranges begin with a lower limit of 1 or more, and end at an upper limit of 10 or less, for example 1 to 1.7, or 3.2 to 8.1, or 5.5 to 10.

For the sake of good order, it should be pointed out, in conclusion, that for a better understanding of the structure, some elements were shown not to scale and/or greater in size and/or less in size.

### REFERENCE SYMBOL LISTING

1 vehicle
2 lifting device
3 first cross member
4 second cross member
5 connection construction
6 free space
7 longitudinal axis vehicle
8 longitudinal direction of the vehicle
9 transverse direction of the vehicle
10 first travel direction
11 second travel direction
12 driver's cab
13 contact plane
14 edge of the cross members
15 first wheel pair, first cross member
16 wheel
17 second wheel pair, second cross member
18 first axle
19 second axle
20 lift mast
21 component to be transported
22 carriage
23 forklift fork
24 first side, lift mast
25 first guide unit
26 second side, lift mast
27 second guide unit
28 wheel holder
29 radial mounting
30 horizontally oriented axis of rotation
31 axial mounting
32 vertically oriented axis of rotation
33 rotary motor
34 pinion
35 traction means
36 gear wheel
37 drive chain
38 drive motor for wheels
39 horizontal axis of rotation of the axle
40 axle holder
41 rotary mounting
42 setting means
43 linear guide
44 angle
45 angle of rotation sensor

1. A vehicle (1) having a lateral lifting device (2), in particular a side loader, comprising at least a first cross member (3) and a second cross member (4), wherein the two cross members (3, 4) are coupled with one another by means of a connection construction (5) that is disposed laterally outside the center, and wherein the lifting device (2) is disposed in a free space (6) between the two cross members (3, 4), wherein the connection construction (5) is disposed at the lateral edge (14) of the cross members (3, 4), so that the vehicle (1) is configured in U shape in a top view, and wherein the two shanks of the vehicle (1) configured in U shape, which shanks lie parallel to one another, are formed by the cross members (3, 4), and the free space (6) for accommodating the lifting device (2) is configured on the open side of the U-shaped arrangement, wherein the first cross member (3) has a first wheel pair (15), and the second cross member (4) has a second wheel pair (17), wherein each of the individual wheels (16) of the wheel pairs (15, 17) is mounted so as to rotate about an axis of rotation (32) that is oriented vertically, and wherein the vehicle (1) can be moved in a first travel direction (10) parallel to a longitudinal axis (7) of the vehicle (1), and in a second travel direction (11) transverse to the longitudinal axis (7) of the vehicle (1).

2. The vehicle according to claim 1, wherein a first axle (18) is configured on the first cross member (3), which axle serves to hold the first wheel pair (15), and a second axle (19) is configured on the second cross member (4), which axle serves to hold the second wheel pair (17).

3. The vehicle according to claim 1, wherein each of the individual wheels (16) is held on a wheel holder (28), which wheel holder (28) has a radial mounting (29) having a horizontally oriented axis of rotation (30), for holding a wheel (16) in rotatable manner, and an axial mounting (31) having a vertically oriented axis of rotation (32), by means of which the wheel holder (28) is mounted on the cross members (3, 4) so as to rotate freely about the vertically oriented axis of rotation (32).

4. The vehicle according to claim 2, wherein the axles (18, 19) are held, in each instance, approximately in the center of the cross members (3, 4) with reference to a horizontal axis of rotation (39), mounted in pendulum manner.

5. The vehicle according to claim 2, wherein the axles are held, in each instance, outside of the center of the cross members (3, 4), with reference to a horizontal axis of rotation (39), mounted in pendulum manner.

6. The vehicle according to claim 4, wherein the axles (18, 19) are coupled with the respective cross member (3, 4), in each instance, by means of at least one setting means (42) disposed at a distance from the horizontal axis of rotation (39).

7. The vehicle according to claim 2, wherein the individual wheels (16) are held on the axles (18, 19) of the cross members (3, 4) by means of the axial mounting (31) configured on the wheel holder (28), having a vertically oriented axis of rotation (32), so as to rotate freely.

8. The vehicle according to claim 2, wherein the axles (18, 19) are coupled with the respective cross member (3, 4), in each instance, by means of at least two setting means (42) that are spaced apart from one another, and wherein the axle (18, 19) can be pivoted with reference to the cross member (3, 4), about a virtual horizontal axis of rotation (39), by adjusting the setting means (42).

9. The vehicle according to claim 1, wherein a rotary motor (33) is provided, on which a pinion (34) is disposed, and which is coupled with a gear wheel (36) configured on the wheel holder (28), by means of a mechanical coupling, preferably a circulating traction means (35).

10. The vehicle according to claim 9, wherein the traction means (35) is configured in the form of a drive chain (37).

11. The vehicle according to claim 9, wherein the rotary motor (33) is configured as a hydraulic motor.

12. The vehicle according to claim 1, wherein a hydraulic cylinder is provided, by means of which the wheel holder (28) can be rotated about the vertically oriented axis of rotation (32).

13. The vehicle according to claim 1, wherein each of the individual wheels (16) of the vehicle (1) is coupled, in each instance, with a drive motor (38) for driving the wheels (16).

14. The vehicle according to claim 13, wherein the drive motor (38) for driving the wheels (16) is configured as a hydraulic motor.

15. The vehicle according to claim 3, wherein the wheel holder (28) can be rotated, in the vertically oriented axis of rotation (32), by a maximal angle (44) between 180° and 400°, in particular between 210° and 360°, preferably between 250° and 290°.

16. The vehicle according to claim 1, wherein the lifting device (2) comprises a lift mast (20), which is accommodated in the free space (6) of the vehicle (1), wherein the lift mast (20) is accommodated in the free space (6) so as to be displaceable in the transverse direction (9) of the vehicle (1).

17. The vehicle according to claim 3, wherein at least two of the wheels (16) have a diameter between 10 inches and 50 inches, in particular between 12 inches and 50 inches, preferably between 14 inches and 50 inches.

18. The vehicle according to claim 3, wherein all the wheels (16) have a diameter between 10 inches and 50 inches, in particular between 12 inches and 50 inches, preferably between 14 inches and 50 inches.

19. The vehicle according to claim 1, wherein a contact plane (13) is configured, on which elongated objects picked up by the lifting device (2) can be laid down, wherein the contact plane (13) is disposed above the wheels (16).
